(19) United States
(12) Patent Application Publication
(10) Pub. No.: US 2024/0059971 A1
(43) Pub. Date: Feb. 22, 2024

(54) HEAT-INSULATING FIREPROOF STRUCTURE AND METHOD OF MANUFACTURING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); SHIH-HSUN YEN, TAIPEI (TW)

(21) Appl. No.: 17/989,626

(22) Filed: Nov. 17, 2022

(30) Foreign Application Priority Data
Aug. 18, 2022 (TW) 111131052

(51) Int. Cl. C09K 21/02

(52) U.S. Cl. CPC C09K 21/02

(57) ABSTRACT

A heat-insulating fireproof structure and a method of manufacturing the heat-insulating fireproof structure are provided. The heat-insulating fireproof structure includes a fireproof fiber layer, and at least one fireproof reinforcement layer. The fireproof fiber layer includes an inorganic aerogel. The inorganic aerogel is present in the fireproof fiber layer by being attached on surfaces of fibers therein. Based on the fireproof fiber layer being 100 wt %, a content of the inorganic aerogel is from 20 wt % to 50 wt %.

### CROSS-REFERENCE TO RELATED PATENT APPLICATION

This application claims the benefit of priority to Taiwan Patent Application No. 111131052, filed on Aug. 18, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a heat-insulating fireproof structure, and more particularly to a heat-insulating fireproof structure including inorganic aerogel, and a method for manufacturing the heat-insulating fireproof structure.

### BACKGROUND OF THE DISCLOSURE

Most sewer pipes or electrical wirings in general households or buildings are made of inflammable plastics. When a fire occurs, the inflammable plastics not only promote the fire, but also generate dense smoke and harmful gases that become the main obstacle of preventing people from escaping the fire, thus causing economic losses and hazards to personal safeties. At present, authorities concerned have formulated relevant fire regulations to regulate the heat-insulating or fire resistance properties of pipelines in general households or buildings, such that when a fire occurs, pipelines, beams and columns, and walls of the buildings that have inflammable properties are prevented from burning and promoting the fire.

However, most of the existing fireproof materials and fireproof structures used in general households or industries are only single-layered. A small part of the existing fireproof materials and fireproof structures have multiple layers, but have poor fireproof property and flame resistance. Such fireproof materials and fireproof structures may be suitable for purposes of escaping a fire in a general household, or preventing damages caused by sparks from electric welding, but when these fireproof materials and fireproof structures are used to coat smooth or irregular surfaces on pipelines, beams and columns and walls of the building, or set in interlayers of buildings, effects such as heat insulation, and fire and flame retardant cannot be sufficiently achieved.

Accordingly, how to improve a fireproofing degree and flame resistance of a fireproof structure to solve the problem of existing heat-insulating fireproof structure is an issue to be addressed in the relevant field.

### SUMMARY OF THE DISCLOSURE

In response to the above-referenced technical inadequacies, the present disclosure provides a heat-insulating fireproof structure and a method of manufacturing the heat-insulating fireproof structure.

In one aspect, the present disclosure provides a heat-insulating fireproof structure. The heat-insulating fireproof structure includes a fireproof fiber layer, and at least one fireproof reinforcement layer. The at least one fireproof reinforcement layer is formed on the fireproof fiber layer. The fireproof fiber layer includes an inorganic aerogel that is present in the fireproof fiber layer by being attached on surfaces of fibers in the fireproof fiber layer, and based on the fireproof fiber layer being 100 wt %, a content of the inorganic aerogel is from 20 wt % to 50 wt %.

In certain embodiments, the fireproof fiber layer is made from water soluble alkali fiber or silicate fiber.

In certain embodiments, the at least one fireproof reinforcement layer is made of glass fiber, carbon fiber, silicone rubber, or a combination thereof.

In certain embodiments, a thickness of the fireproof fiber layer is from 0.2 mm to 250 mm.

In certain embodiments, a thickness of the at least one fireproof reinforcement layer is from 0.015 mm to 0.5 mm.

In certain embodiments, the inorganic aerogel is formed in the fireproof fiber layer by impregnation or coating.

In certain embodiments, the inorganic aerogel is porous silica, aluminum, chromium, stannic oxide, or carbon or a combination thereof.

In certain embodiments, the fireproof fiber layer has a first surface and a second surface that are opposite to each other, a quantity of the at least one fireproof reinforcement layer is one, and the at least one fireproof reinforcement layer is formed on the first surface or the second surface.

In certain embodiments, the fireproof fiber layer is integrated with the at least one fireproof reinforcement layer by needle punching or thermal bonding.

In certain embodiments, the fireproof fiber layer has a first surface and a second surface that are opposite to each other, a quantity of the at least one fireproof reinforcement layer is two, and the at least one fireproof reinforcement layer is formed on the first surface and the second surface respectively.

In certain embodiments, the fireproof fiber layer is integrated with the at least one fireproof reinforcement layer by needle punching or thermal bonding.

In another aspect, the present disclosure provides a method of manufacturing a heat-insulating fireproof structure. The method includes: providing a fireproof fiber layer; forming at least one fireproof reinforcement layer on the fireproof fiber layer; and forming an inorganic aerogel in the fireproof fiber layer, so that the inorganic aerogel is evenly distributed in the fireproof fiber layer, and based on the fireproof fiber layer being 100 wt %, a content of the inorganic aerogel is from 20 wt % to 50 wt %.

In certain embodiments, the fireproof fiber layer has a first surface and a second surface that are opposite to each other, a number of the at least one fireproof reinforcement layer is one, and the at least one fireproof reinforcement layer is formed on the first surface or the second surface.

In certain embodiments, the fireproof fiber layer has a first surface and a second surface that are opposite to each other, a quantity of the at least one fireproof reinforcement layer is two, and the at least one fireproof reinforcement layer is formed on the first surface and the second surface respectively.

Therefore, in the heat-insulating fireproof structure and the method of manufacturing the heat-insulating fireproof structure provided by the present disclosure, by virtue of “at least one fireproof reinforcement layer being formed on the fireproof fiber layer,” “the fireproof fiber layer including an inorganic aerogel present in the fireproof fiber layer by being attached on surfaces of fibers in the fireproof fiber layer,” and “based on the fireproof fiber layer being 100 wt %, a content of the inorganic aerogel being from 20 wt % to 50 wt %,” the mechanical strength, reinforcement property, and tensile strength of the heat-insulating fireproof structure can be enhanced while the heat-insulating and fireproof effect are achieved. Moreover, the heat-insulating fireproof structure can be used to coat smooth or irregular surfaces on pipelines, beams and columns and walls of the building, or set in interlayers of buildings, so as to inhibit or delay flames from burning the plastic pipelines. Therefore, the generation of smoke and harmful gases, and the hazards caused by fires are reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A is a schematic view of a first structure of a heat-insulating fireproof structure according to a first embodiment of the present disclosure;

FIG. 1B is a schematic view of a second structure of the heat-insulating fireproof structure according to the first embodiment of the present disclosure;

FIG. 2 is a schematic view of a heat-insulating fireproof structure according to a second embodiment of the present disclosure; and

FIG. 3 is a flowchart of a method of manufacturing a heat-insulating fireproof structure according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

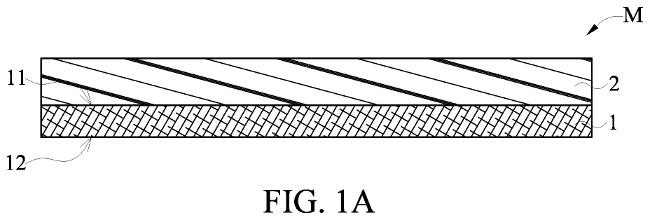

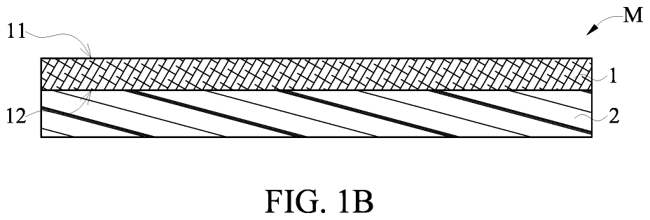

References are made to FIG. 1A and FIG. 1B, which are respectively schematic views of a first structure and a second structure of a heat-insulating fireproof structure according to a first embodiment of the present disclosure. The first embodiment of the present disclosure provides a heat-insulating fireproof structure M. The heat-insulating fireproof structure M includes a fireproof fiber layer 1 and a fireproof reinforcement layer 2. The fireproof fiber layer 1 has a first surface 11 and a second surface 12 that are opposite to each other, and the fireproof reinforcement layer 2 is formed on the first surface 11 or the second surface 12. That is, the fireproof fiber layer 1 and the fireproof reinforcement layer 2 are formed so that the heat-insulating fireproof structure M is formed to have a stereoscopic laminated structure. It should be noted that, as shown in FIG. 1A and FIG. 1B, the heat-insulating fireproof structure M that has the stereoscopic laminated structure is only one example, and a shape of the heat-insulating fireproof structure M is not limited in the present disclosure.

In this embodiment, the fireproof fiber layer 1 is made from water soluble alkali fiber or silicate fiber, but the type of fiber is not limited in the present disclosure. The fireproof fiber layer 1 may be made from water soluble alkali fiber or silicate fiber through plain weaving, knitting, and twill weaving. On the other hand, the fireproof fiber layer 1 may be made by blending water soluble alkali fiber and silicate fiber in a ratio of 1:1, so that a mechanical strength of the fireproof fiber layer 1 is improved. Further, the water soluble alkali fiber and the silicate fiber have better flame retardancy and difficult-flammability, and are capable of self-extinguishing. Therefore, a fireproof fiber that is made of the above mentioned material can improve the fireproof and flame retardancy properties of the heat-insulating fireproof structure M.

Moreover, the fireproof fiber layer 1 may be a fiber woven layer made from water soluble alkali fiber or silicate fiber through the process of producing a staple fiber nonwoven fabric. This process can form a fiber layer having a higher density than a density of a fiber formed through a process of producing a melt-blown nonwoven fabric, so that the mechanical strength of the fireproof fiber layer 1 can be further improved, thereby increasing supporting capacity and tensile strength of the fireproof fiber layer 1.

In the present embodiment, the fireproof fiber layer 1 includes an inorganic aerogel, and the inorganic aerogel is attached on surfaces of fibers, and is presented in the fireproof fiber layer 1 in a continuous or a uniformly dispersed manner Based on the fireproof fiber layer 1 being 100 wt %, a content of the inorganic aerogel is from 20 wt % to 50 wt %, and is preferably from 25 wt % to 40 wt %. For example, in some embodiments, the content of the inorganic aerogel may be 25 wt %, 30 wt %, 35 wt %, 40 wt % or 45 wt %, but the present disclosure is not limited thereto.

In the present embodiment, the inorganic aerogel is made of porous silica, aluminum, chromium, stannic oxide, carbon, or a combination thereof, but the present disclosure is not limited thereto. In addition, the inorganic aerogel is formed in the fireproof fiber layer by impregnation or coating. For example, in some embodiments, the inorganic aerogel is manufactured by a sol-gel process and introduced into the fireproof fiber layer 1 by impregnation. Accordingly, a binding force of the inorganic aerogel and the fireproof fiber layer 1 of the present disclosure is better than a binding force of the inorganic aerogel and a conventional heat-insulating foam, and a synergistic effect of fireproofing and heat-insulating can be provided. It should be noted that, the inorganic aerogel is an excellent heat insulator, and can effectively isolate the heat transferred by heat conduction and heat convection. Therefore, in the present disclosure, the inorganic aerogel is introduced into the fireproof fiber layer 1 to provide good heat insulation and fireproof effects. In addition, the inorganic aerogel also has high mechanical strength that is beneficial to the reinforcement capacity of the fireproof fiber layer 1. Moreover, the molecular scaffold of the inorganic aerogels is not easy to collapse and crack during and after combustion, so that a target item that is coated by the heat-insulating fireproof structure M can be protected.

In practice, due to the inorganic aerogel having high porosity and high water-absorbency, the inorganic aerogel can quickly absorb the water sprayed by the fire protection sprinkler system of the building when a fire occurs, so that the fireproof fiber layer 1 contains a large amount of water to improve the heat-insulating and fireproof effect of the heat-insulating fireproof structure M. Accordingly, the heat-insulating fireproof structure M can reduce the damage of fire inflicted on important structures or facilities such as pipelines, beams and columns, and walls of the building, inhibit or delay the ablation of flames to pipelines, and reduce the generation of dense smoke and harmful gases, so as to reduce the hazard caused by fire.

In the present embodiment, a thickness of the fireproof fiber layer 1 is from 0.2 mm to 250 mm, and is preferably from 10 mm to 100 mm. For example, in some embodiments, a thickness of the fireproof fiber layer 1 can be 10 mm, 50 mm, 100 mm, or 200 mm. When the thickness of the fireproof fiber layer 1 exceeds 100 mm, the binding force of the fireproof fiber layer 1 and the fireproof reinforcement layer 2 becomes insufficient, thus causing a problem of difficulty in bonding. When the thickness of the fireproof fiber layer 1 becomes too large, it is also unfavorable for needle punching or thermal bonding process, such that the processing cost is greatly increased. In the present embodiment, a material of the fireproof reinforcement layer 2 is glass fiber, carbon fiber, silicone rubber, fluoro rubber, or a combination of one or more thereof. The fireproof reinforcement layer 2 can be made from glass fiber or carbon fiber woven layer, or made from silicone rubber, fluoro rubber through plain weave, knitted, and twill weave. Furthermore, the fireproof reinforcement layer 2 can be made by blending metal fiber and glass fiber in a ratio of 1:2, so that the fireproof reinforcement layer 2 and the fireproof fiber layer 1 can generate a synergistic effect for fireproof reinforcement, and improve the mechanical strength and increase the tensile strength of the heat-insulating fireproof structure M. However, the material of the fireproof reinforcement layer 2 is not limited to the examples provided herein.

In the present embodiment, a thickness of the fireproof reinforcement layer 2 is from 0.015 mm to 0.5 mm, and is preferably from 0.05 mm to 0.2 mm. For example, in some embodiments, a thickness of the fireproof reinforcement layer 2 is 0.02 mm, 0.05 mm, 0.1 mm, 0.2 mm, 0.3 mm, or 0.4 mm. As described above, when the thickness of the fireproof reinforcement layer 2 exceeds 0.5 mm, it is difficult for the fireproof reinforcement layer 2 to bind with the fireproof fiber layer 1. In addition, although the fireproof reinforcement layer 2 can increase the overall mechanical strength and tensile strength of the heat-insulating fireproof structure M, when the thickness of the heat-insulating fireproof structure M becomes too large, the tensile strength, flexibility, and bendability of the heat-insulating fireproof structure M are decreased, and the cladding and tightness when the heat-insulating fireproof structure M is covered on a target item is negatively affected, which makes it unfavorable for the heat-insulating fireproof structure M to tightly attach on large angled bends, curved surfaces, or surfaces that are not completely flat.

In the present embodiment, the fireproof fiber layer 1 is integrated with the fireproof reinforcement layer 2 by needle punching or thermal bonding to form the heat-insulating fireproof structure M. When the heat-insulating fireproof structure M is integrally formed by needle punching, the mechanical strength and hardness of the fireproof fiber layer 1 and the fireproof reinforcement layer 2 can be adjusted by selecting a thickness of needles of a needle punching mill, a number of needle punching, and a depth of needle punching.

It is worth mentioning that, when the fireproof fiber layer 1 is integrated with the fireproof reinforcement layer 2 by needle punching, if the thickness of the fireproof reinforcement layer 2 is smaller than 0.015 mm, holes will be easily formed. On the other hand, if the thickness of the fireproof reinforcement layer 2 exceeds 0.5 mm, the rolling needles of the needle punching mill will be worn out too fast, such that a quality of the needle punching becomes difficult to control.

Further, when the integrated heat-insulating fireproof structure M is formed by thermal bonding, the mechanical strength and hardness of the fireproof fiber layer 1 and the fireproof reinforcement layer 2 are adjusted by infiltrating the silicone rubber into a predetermined depth at a high temperature between the adjacent fireproof fiber layer 1 and the fireproof reinforcement layer 2. That is, the mechanical strength, hardness, and tensile strength of the heat-insulating fireproof structure M can be adjusted by needle punching or thermal bonding compression, or a combination thereof, so as to meet the requirements of practical applications. Accordingly, the heat-insulating fireproof structure M can be adopted in different applications in various situations. For example, the heat-insulating fireproof structure M can be used for escaping a fire in a general household, preventing damages caused by sparks from electric welding, and coating pipelines, beams and columns, or can be placed in interlayers of buildings.

Specifically, the heat-insulating fireproof structure M provided in the present disclosure has the characteristics of being difficult to catch fire, incombustible, and heat-insulating. Therefore, the heat-insulating fireproof structure M can be produced into a fireproof blanket that can be used to cover a burning item. By blocking the supply of oxygen, the flame can be extinguished. In practice, the fireproof blanket is suitable for extinguishing fires or fires that have just occurred but have not yet spread, but cannot effectively control out-of-control or large scale fires. In addition, for fires that are out of control, the fire blanket may be covered on a body of a person to prevent burns from flames when the person escapes from the fire, so that the fire blanket is beneficial in improving personal safety.

### Second Embodiment

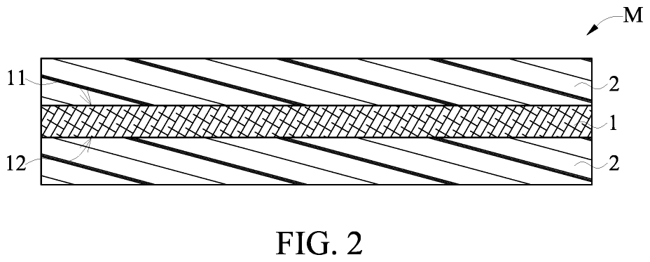

Referring to FIG. 2, in conjunction with FIG. 1A and FIG. 1B, FIG. 2 is a schematic view of a heat-insulating fireproof structure according to a second embodiment of the present disclosure. The second embodiment of the present disclosure provides a heat-insulating fireproof structure M. The heat-insulating fireproof structure M includes a fireproof fiber layer 1, and the fireproof fiber layer 1 has a first surface 11 and a second surface 12. One of the differences between the present embodiment and the first embodiment is that, the heat-insulating fireproof structure M includes two fireproof reinforcement layers 2 that are respectively formed on the first surface 11 and the second surface 12 of the fireproof fiber layer 1.

That is, the fireproof fiber layer 1 and the two fireproof reinforcement layers 2 are arranged in a sequence of one of the two fireproof reinforcement layers 2, the fireproof fiber layer 1, and another one of the two fireproof reinforcement layers 2 to form a heat-insulating fireproof structure M having a three-layered and laminated structure. As shown in FIG. 2, it is worth mentioning that the heat-insulating fireproof structure M having a laminated structure is only one example, and the shape of the heat-insulating fireproof structure M is not limited in the present disclosure.

Further, the two fireproof reinforcement layers 2 are beneficial in further improving the mechanical strength and tensile strength of the heat-insulating fireproof structure M, so that the heat-insulating fireproof structure M is not easily damaged during practical usage, and applications that the heat-insulating fireproof structure M can be applied to are increased. In addition, the fireproof fiber layer 1 and the two fireproof reinforcement layers 2 can be combined into an integrated heat-insulating fireproof structure M by needle punching, thermal bonding, or a combination thereof. However, the present disclosure does not limit the two fireproof reinforcement layers 2 to be integrated in the same way. That is, the two fireproof reinforcement layers 2 can be formed on the first surface 11 of the fireproof fiber layer 1 by needle punching, and formed on the second surface 12 of the fireproof fiber layer 1 by thermal bonding, respectively. Conversely, the two fireproof reinforcement layers 2 can be formed on the second surface 12 of the fireproof fiber layer 1 by needle punching, and be formed on the first surface 11 of the fireproof fiber layer 1 by thermal bonding, or other combinations of needle punching and thermal bonding, respectively.

The technical features and implementations of the fireproof fiber layer 1 and the fireproof reinforcement layers 2 have been described in the first embodiment, and will not be repeated herein.

### Third Embodiment

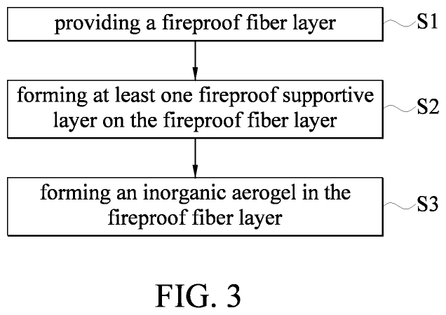

Reference is made to FIG. 3, which is a flowchart of a method of manufacturing a heat-insulating fireproof structure according to a third embodiment of the present disclosure. The present disclosure further provides a method of manufacturing the heat-insulating fireproof structure M. The method includes the following steps:
S1: providing a fireproof fiber layer 1 that has a first surface 11 and a second surface 12 that are opposite to each other;
S2: forming at least one fireproof reinforcement layer 2 on the fireproof fiber layer 1; and
S3: forming an inorganic aerogel in the fireproof fiber layer 1, so that the inorganic aerogel is evenly distributed in the fireproof fiber layer 1, and based on the fireproof fiber layer 1 being 100 wt %, a content of the inorganic aerogel is from 20 wt % to 50 wt %.

Further, in the present disclosure, when a quantity of the at least one fireproof reinforcement layer 2 is one, the fireproof reinforcement layer 2 is formed on one of the first surface 11 or the second surface 12; when the quantity of the at least one fireproof reinforcement layer 2 is two, the two fireproof reinforcement layers 2 are formed on the first surface 11 and the second surface 12, respectively.

The technical features and implementations of the fireproof fiber layer 1 and the fireproof reinforcement layers 2 have been described in the first embodiment, and will not be repeated herein.

[Test and Experiment Method]

The test of bursting strength (kg/cm²) includes steps as follows.

Firstly, cutting out a test piece of the same size (e.g., a length of 100 mm, and a width of 30 mm) along a longitudinal direction and a transverse direction of a sample; placing the test piece on the a seat of a burst testing machine with a front of the test piece facing upward, and confirming that a red pointer of a pressure gauge is at a zero position; pressing down a pressure rod, so that a pressure seat presses against the test piece; when the rubber film is inflated and breaks the test piece, immediately move the pressure rod to a decompression position, so that the pressure seat rises, the rubber film is decompressed, and a position of the red pointer of the pressure gauge is read and recorded.

The test of flame retardancy includes steps as follows.

Using a cone calorimeter to test the combustion heat release rate of a test material subjected to different heating durations according to the protocol of ASTME1354; under a heating condition of 50 kW/m², the test material is heated for 20 minutes, 10 minutes and 5 minutes, respectively; depending on whether or not the test material meets the heating conditions of the following protocol standards 1 to 3, a heat resistance level of the test material is determined: 1. The total heat release amount of the test material is below 8 MJ/m²; 2. The time in which the maximum heat release rate exceeds 200 kW/m² does not last for more than 10 seconds; 3. Cracks and holes are not present on a rear side of the test material; the heat resistance level of the test material is defined into the following three levels: heat resistance level 1: the test material can meet the above protocol standards 1 to 3 after being heated for 20 minutes; heat resistance level 2: the test material can meet the above protocol standards 1 to 3 after being heated for 10 minutes; heat resistance level 3: the test material can meet the above protocol standards 1-3 after being heated for 5 minutes.

### Beneficial Effects of the Embodiments

In conclusion, in the heat-insulating fireproof structure and the method of manufacturing the heat-insulating fireproof structure provided by the present disclosure, by virtue of “at least one fireproof reinforcement layer formed on the fireproof fiber layer,” and “The fireproof fiber layer includes an inorganic aerogel existed in the fireproof fiber layer through being attached on surfaces of fibers therein. Based on the fireproof fiber layer as 100 wt %, a content of the inorganic aerogel is 20 wt % to 50 wt %,” the mechanical strength of the heat-insulating fireproof structure can be enhanced while achieving heat-insulating and fireproof effect. Moreover, the heat-insulating fireproof structure can be used to coat regular or irregular surfaces on pipelines, beams and columns and walls of the building, or set in the interlayer of buildings, so as to inhibit or delay flames from burning the plastic pipelines. Therefore, the generation of smoke and harmful gases is reduced, and the hazards caused by fires are reduced.

Furthermore, the mechanical strength, hardness, and tensile strength of the heat-insulating fireproof structure can be adjusted by needle punching or thermal bonding compression, or a combination thereof, so as to meet the requirements of practical applications. Accordingly, the heat-insulating fireproof structure M can be adopted in different applications in various situations. For example, the heat-insulating fireproof structure can be used for escaping a fire in a general household, preventing damages caused by sparks from electric welding, and coating pipelines, beams and columns, or can be placed in interlayers of buildings.

Moreover, the heat-insulating fireproof structure M can be produced into a fireproof blanket that can be used to cover a burning item. By blocking the supply of oxygen, the flame can be extinguished. In practice, the fireproof blanket is suitable for extinguishing fires or fires that have just occurred but have not yet spread, but cannot effectively control out-of-control or large scale fires. In addition, for fires that are out of control, the fire blanket may be covered on a body of a person to prevent burns from flames when the person escapes from the fire, so that the fire blanket is beneficial in improving personal safety.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A heat-insulating fireproof structure, comprising:
a fireproof fiber layer; and
at least one fireproof reinforcement layer formed on the fireproof fiber layer;
wherein the fireproof fiber layer includes an inorganic aerogel that is present in the fireproof fiber layer by being attached on surfaces of fibers in the fireproof fiber layer, and based on the fireproof fiber layer being 100 wt %, a content of the inorganic aerogel is from 20 wt % to 50 wt %.

2. The heat-insulating fireproof structure according to claim 1, wherein the fireproof fiber layer is made from water soluble alkali fiber or silicate fiber.

3. The heat-insulating fireproof structure according to claim 1, wherein the at least one fireproof reinforcement layer is made of glass fiber, carbon fiber, silicone rubber, or a combination thereof.

4. The heat-insulating fireproof structure according to claim 1, wherein a thickness of the fireproof fiber layer is from 0.2 mm to 250 mm.

5. The heat-insulating fireproof structure according to claim 1, wherein a thickness of the at least one fireproof reinforcement layer is from 0.015 mm to 0.5 mm.

6. The heat-insulating fireproof structure according to claim 1, wherein the inorganic aerogel is formed in the fireproof fiber layer by impregnation or coating.

7. The heat-insulating fireproof structure according to claim 1, wherein the inorganic aerogel is porous silica, aluminum, chromium, stannic oxide, carbon, or a combination thereof.

8. The heat-insulating fireproof structure according to claim 1, wherein the fireproof fiber layer has a first surface and a second surface that are opposite to each other, a quantity of the at least one fireproof reinforcement layer is one, and the at least one fireproof reinforcement layer is formed on the first surface or the second surface.

9. The heat-insulating fireproof structure according to claim 8, wherein the fireproof fiber layer is integrated with the at least one fireproof reinforcement layer by needle punching or thermal bonding.

10. The heat-insulating fireproof structure according to claim 1, wherein the fireproof fiber layer has a first surface and a second surface that are opposite to each other, a quantity of the at least one fireproof reinforcement layer is two, and the at least one fireproof reinforcement layer is formed on the first surface and the second surface, respectively.

11. The heat-insulating fireproof structure according to claim 10, wherein the fireproof fiber layer is integrated with the at least one fireproof reinforcement layer by needle punching or thermal bonding.

12. A method of manufacturing a heat-insulating fireproof structure, comprising:
providing a fireproof fiber layer;
forming at least one fireproof reinforcement layer on the fireproof fiber layer; and
forming an inorganic aerogel in the fireproof fiber layer, so that the inorganic aerogel is evenly distributed in the fireproof fiber layer, and based on the fireproof fiber layer being 100 wt %, a content of the inorganic aerogel is from 20 wt % to 50 wt %.

13. The method according to claim 12, wherein the fireproof fiber layer has a first surface and a second surface that are opposite to each other, a quantity of the at least one fireproof reinforcement layer is one, and the at least one fireproof reinforcement layer is formed on the first surface or the second surface.

14. The method according to claim 12, wherein the fireproof fiber layer has a first surface and a second surface that are opposite to each other, a quantity of the at least one fireproof reinforcement layer is two, and the at least one fireproof reinforcement layer is formed on the first surface and the second surface, respectively.
